(19) United States
(12) Patent Application Publication
(10) Pub. No.: US 2026/0121295 A1
(43) Pub. Date: Apr. 30, 2026

(54) MULTI-RESONANT ANTENNA

(71) Applicant: Japan Aviation Electronics Industry, Limited, Tokyo (JP)

(72) Inventor: Hiroshi TOYAO, Tokyo (JP)

(73) Assignee: Japan Aviation Electronics Industry, Limited, Tokyo (JP)

(21) Appl. No.: 19/318,519

(22) Filed: Sep. 4, 2025

(30) Foreign Application Priority Data
Oct. 24, 2024 (JP) 2024-187252

(51) Int. Cl. H01Q 5/307

(52) U.S. Cl. CPC H01Q 5/307

(57) ABSTRACT

A multi-resonant antenna comprises a main antenna and an additional radiation element. The main antenna comprises a main portion and a feeding portion. The main portion has a closed ring shape. The feeding portion has a first feeding part, a second feeding part, a first feeding point and a second feeding point. Each of the first feeding part and the second feeding part extends outward of the main antenna from the main portion. The first feeding point is provided at the first feeding part. The second feeding point is provided at the second feeding part. The additional radiation element extends outward of the main antenna directly from the first feeding part.

This application is based on and claims priority under 35 U.S.C. §119 to Japanese Patent Applications No. JP 2024-187252 filed October 24, 2024, the contents of which are incorporated herein in their entirety by reference.

### BACKGROUND OF THE INVENTION

This invention relates to a multi-resonant antenna.

JPB 6020451 (Patent Document 1) discloses a small and broadband antenna 900. As shown in FIG. 10, the antenna 900 of Patent Document 1 has a split-ring resonator 910 using a split-ring 920 which is an annular conductor with a split portion 922. Specifically, the antenna 900 of Patent Document 1 has a main portion 930 and a feeding portion 940. The main portion 930 forms the sprit-ring 920. The feeding portion 940 is provided to the main portion 930.

The antenna 900 of Patent Document 1 operates at a resonant frequency of the sprit-ring resonator 910. In other words, the antenna 900 of Patent Document 1 resonates at only one operating frequency but cannot cope with a broad frequency band.

### SUMMARY OF THE INVENTION

It is therefore an object of the present invention to provide an antenna having a structure which can resonate at a plurality of operating frequencies.

One aspect of the present invention provides a multi-resonant antenna comprising a main antenna and an additional radiation element. The main antenna comprises a main portion and a feeding portion. The main portion has a closed ring shape. The feeding portion has a first feeding part, a second feeding part, a first feeding point and a second feeding point. Each of the first feeding part and the second feeding part extends outward of the main antenna from the main portion. The first feeding point is provided at the first feeding part. The second feeding point is provided at the second feeding part. The additional radiation element extends outward of the main antenna directly from the first feeding part.

The multi-resonant antenna of the present invention comprises the additional radiation element in addition to the main antenna. With this structure, the multi-resonant antenna of the present invention can resonate at both of an operating frequency of the main antenna and an operating frequency of the additional radiation element. In other words, the multi-resonant antenna of the present invention has a structure which can resonate at a plurality of operating frequencies.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a top view showing a multi-resonant antenna according to an embodiment of the present invention.

FIG. 2 is a top view showing a first modification of the multi-resonant antenna of FIG. 1.

FIG. 3 is a top view showing a second modification of the multi-resonant antenna of FIG. 1.

FIG. 4 is a top view showing a third modification of the multi-resonant antenna of FIG. 1.

FIG. 5 is a top view showing a fourth modification of the multi-resonant antenna of FIG. 1.

FIG. 6 is a top view showing a fifth modification of the multi-resonant antenna of FIG. 1.

FIG. 7 is a top view showing a sixth modification of the multi-resonant antenna of FIG. 1.

FIG. 8 is a top view showing a seventh modification of the multi-resonant antenna of FIG. 1.

FIG. 9 is a top view showing an eighth modification of the multi-resonant antenna of FIG. 1.

FIG. 10 is a top view showing an antenna disclosed in Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

### First embodiment

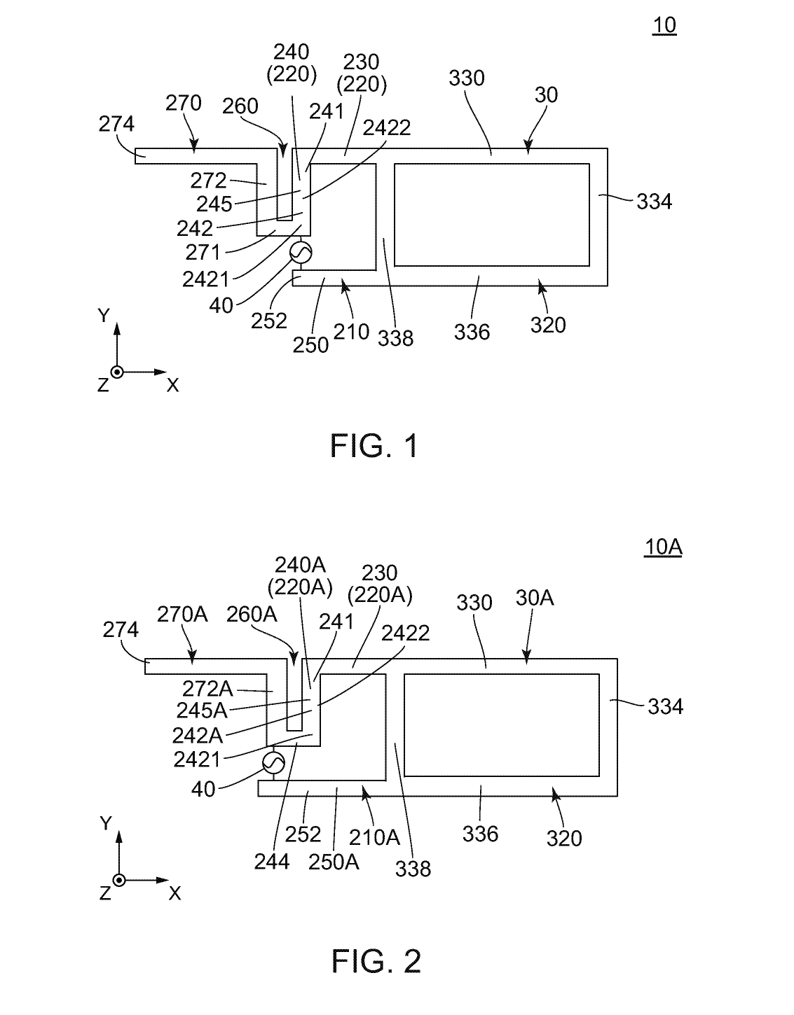

As shown in FIG. 1, a multi-resonant antenna 10 according to an embodiment of the present invention comprises a main antenna 30 and an additional radiation element 270. There is no ground conductor around the multi-resonant antenna 10 of the present embodiment.

As shown in FIG. 1, the main antenna 30 and the additional radiation element 270 are positioned on a common plane perpendicular to an up-down direction. In the present embodiment, the up-down direction is a Z-direction. Specifically, a positive Z-direction is upward while a negative Z-direction is downward. The multi-resonant antenna 10 is configured so that the main antenna 30 and the additional radiation element 270 are integrally formed with each other. A combination of the main antenna 30 and the additional radiation element 270 is formed of a conductive pattern formed on a substrate (not shown). However, the present invention is not limited thereto. Specifically, the combination of the main antenna 30 and the additional radiation element 270 may be formed of, for example, a metal member which is mounted on a substrate when used. If the combination of the main antenna 30 and the additional radiation element 270 is formed by microfabrication techniques, the combination of the main antenna 30 and the additional radiation element 270, which is formed of the conductive pattern formed on the substrate, has a mechanical strength greater than a mechanical strength of the combination of the main antenna 30 and the additional radiation element 270 which is formed of the metal member mounted on the substrate when used. Accordingly, the combination of the main antenna 30 and the additional radiation element 270 is preferred to be formed of the conductive pattern formed on the substrate.

Referring to FIG. 1, the main antenna 30 is a resonant antenna and has an operating frequency, or a resonant frequency, which is defined by its shape and size. The main antenna 30 comprises a main portion 320 and a feeding portion 210. Specifically, the main portion 320 has a closed ring shape.

As shown in FIG. 1, a shape of the main portion 320 of the present embodiment is an approximately rectangular ring shape long in a lateral direction. However, the present invention is not limited thereto. The shape of the main portion 320 of the present invention may be any one of various ring shapes, such as not only the approximately rectangular ring shape but also an annular shape, an elliptical annular shape and a polygonal annular shape. In the present embodiment, the lateral direction is an X-direction. Specifically, a negative X-direction is also referred to as a first predetermined direction in the present embodiment.

As shown in FIG. 1, the main portion 320 has a first portion 330, a second portion 334, a third portion 336 and a fourth portion 338. Each of the first portion 330 and the third portion 336 extends in the lateral direction. The first portion 330 and the third portion 336 are spaced apart from each other in a front-rear direction. The first portion 330 and the third portion 336 are arranged parallel to each other. Each of the second portion 334 and the fourth portion 338 extends in the front-rear direction. The second portion 334 and the fourth portion 338 are spaced apart from each other in the lateral direction. The second portion 334 and the fourth portion 338 are arranged parallel to each other. In the present embodiment, the front-rear direction is a Y-direction. Specifically, it is assumed that a positive Y-direction is forward while a negative Y-direction is rearward. In the present embodiment, the negative Y-direction is also referred to as a second predetermined direction, and the positive Y-direction is also referred to as a third predetermined direction.

As shown in FIG. 1, the first portion 330 is positioned beyond the second portion 334 in the first predetermined direction. The third portion 336 is positioned beyond the first portion 330 in the second predetermined direction. The fourth portion 338 is positioned beyond the second portion 334 in the first predetermined direction. The second portion 334 couples the first portion 330 and the third portion 336 with each other. The fourth portion 338 couples the first portion 330 and the third portion 336 with each other.

As shown in FIG. 1, the feeding portion 210 extends outward of the main antenna 30 from the main portion 320. The feeding portion 210 is positioned at a location beyond the main portion 320 in the first predetermined direction, or in the negative X-direction. However, the present invention is not limited thereto. The feeding portion 210 may be arranged at a location other than the location beyond the main portion 320 in the negative X-direction. The feeding portion 210 has a first feeding part 220, a second feeding part 250, a first feeding point 2421 and a second feeding point 252.

As shown in FIG. 1, the first feeding part 220 extends outward of the main antenna 30 from the main portion 320. The first feeding part 220 extends from the main portion 320 to the first feeding point 2421. The first feeding part 220 has a first section 230 and a second section 240.

As shown in FIG. 1, the first section 230 extends in the first predetermined direction from the main portion 320. Specifically, the first section 230 extends linearly in the first predetermined direction from the main portion 320. However, the present invention is not limited. The first section 230 may have any shape, provided that the first section 230 extends in the first predetermined direction from the main portion 320. The first section 230 is positioned at a position same as a position of the first portion 330 in the front-rear direction. The first section 230 is positioned in the first predetermined direction beyond the first portion 330.

As shown in FIG. 1, the second section 240 extends from the first section 230 in the second predetermined direction intersecting with the first predetermined direction. Specifically, the second section 240 extends from the first section 230 in the second predetermined direction perpendicular to the first predetermined direction. The second section 240 extends in the second predetermined direction from an end portion of the first section 230 in the first predetermined direction. The second section 240 has a linear portion 2422 extending linearly in the second predetermined direction. More specifically, the second section 240 consists only of the linear portion 2422 extending linearly in the second predetermined direction. However, the present invention is not limited. The second section 240 may have any shape, provided that the second section 240 extends in the second predetermined direction from the first section 230.

As shown in FIG. 1, the second section 240 has a first segment 241 and a second segment 242.

As shown in FIG. 1, the first segment 241 extends from the first section 230. Specifically, the first segment 241 extends linearly in the second predetermined direction from the first section 230. The first segment 241 extends linearly in the second predetermined direction from the end portion of the first section 230 in the first predetermined direction.

As shown in FIG. 1, the second segment 242 extends from the first segment 241. Specifically, the second segment 242 extends linearly in the second predetermined direction from the first segment 241. In the second predetermined direction, a middle 245 of the second section 240 is positioned between the first segment 241 and the second segment 242. Specifically, in the second predetermined direction, the middle 245 of the second section 240 is positioned on a boundary between the first segment 241 and the second segment 242.

As shown in FIG. 1, the second feeding part 250 extends outward of the main antenna 30 from the main portion 320. The second feeding part 250 extends from the main portion 320 to the second feeding point 252. Specifically, the second feeding part 250 extends linearly in the first predetermined direction from the main portion 320 to the second feeding point 252. The second feeding part 250 is positioned at a position same as a position of the third portion 336 in the front-rear direction. The second feeding part 250 is positioned in the first predetermined direction beyond the third portion 336.

As shown in FIG. 1, the first feeding point 2421 is provided at the first feeding part 220. The first feeding point 2421 is provided at an end portion of the second section 240 in the second predetermined direction. More in detail, the first feeding point 2421 is provided at an end portion of the second segment 242 in the second predetermined direction. An excitation source 40 is connected to the first feeding point 2421. Specifically, a core wire (not shown) of a coaxial cable (not shown) is connected to the first feeding point 2421.

As shown in FIG. 1, the second feeding point 252 is provided at the second feeding part 250. The excitation source 40 is connected to the second feeding point 252. Specifically, an outer conductor (not shown) of the coaxial cable is connected to the second feeding point 252.

As shown in FIG. 1, the additional radiation element 270 extends outward of the main antenna 30 directly from the feeding portion 210. The additional radiation element 270 extends outward from the feeding portion 210. The additional radiation element 270 extends in the first predetermined direction from the feeding portion 210. The additional radiation element 270 extends outward of the main antenna 30 directly from the first feeding part 220. The additional radiation element 270 extends in the first predetermined direction from the first feeding part 220.

As shown in FIG. 1, the additional radiation element 270 extends from the second segment 242 including the first feeding point 2421. Accordingly, the additional radiation element 270 extends from the vicinity of the first feeding point 2421. This facilitates impedance matching of the additional radiation element 270.

As shown in FIG. 1, the additional radiation element 270 has an additional linear portion 272 extending linearly in the second predetermined direction. The linear portion 2422 and the additional linear portion 272 are spaced apart from each other in the lateral direction. The linear portion 2422 and the additional linear portion 272 are parallel to each other. The linear portion 2422 and the additional linear portion 272 form an open slot 260 which is opened at its end. This further facilitates impedance matching of the additional radiation element 270. The open slot 260 is opened at its end portion in the third predetermined direction. The longer a length of the open slot 260 in the second predetermined direction, the easier it is to achieve impedance matching of the additional radiation element 270. Accordingly, the open slot 260 is preferred to have a longer length in the second predetermined direction.

As shown in FIG. 1, the additional radiation element 270 has a base portion 271 and a first extending portion 274. The base portion 271 extends in the first predetermined direction from the second segment 242. Specifically, the base portion 271 extends linearly in the first predetermined direction from the second segment 242. The base portion 271 and the first extending portion 274 are coupled with each other by the additional linear portion 272. The additional linear portion 272 extends in the third predetermined direction from the base portion 271. The first extending portion 274 extends in the first predetermined direction from the additional linear portion 272. Specifically, the first extending portion 274 extends linearly in the first predetermined direction from the additional linear portion 272. The first extending portion 274 has a rectangular shape extending long in the lateral direction. However, the present invention is not limited thereto. Specifically, the shape of the first extending portion 274 is not limited to the rectangular shape, and the first extending portion 274 may have a stub at its end portion.

Although the additional radiation element 270 of the present embodiment has the base portion 271, the additional linear portion 272 and the first extending portion 274, the present invention is not limited thereto. The additional radiation element 270 may be configured as follows: the additional radiation element 270 has none of the base portion 271 and the additional linear portion 272; and the additional radiation element 270 consists only of the first extending portion 274 which extends directly from the second segment 242.

The length and shape of the additional radiation element 270 are decided so that the additional radiation element 270 electrically resonates at a desired operating frequency. The desired operating frequency is different from an operating frequency of the main antenna 30.

As understood from FIG. 1, the multi-resonant antenna 10 is configured so that the main antenna 30 is fed from the first feeding point 2421 and the second feeding point 252. The additional radiation element 270 is connected to the feeding portion 210. With this structure, the main antenna 30 operates as a first resonance portion, and the additional radiation element 270 operates as a second resonance portion different from the first resonance portion. The first resonance portion and the second resonance portion have resonant frequencies different from each other. Thus, the multi-resonant antenna 10 of the present embodiment has the structure which can electrically resonate at the two operating frequencies, one of which is the operating frequency of the main antenna 30, or the first resonance portion 30, and the other of which is the operating frequency of the additional radiation element 270, or the second resonance portion 270.

Up to this point, the description has been made about the embodiment of the present invention, and the embodiment may be modified as follows.

### First modification

As shown in FIG. 2, a multi-resonant antenna 10A of a first modification comprises a main antenna 30A and an additional radiation element 270A. There is no ground conductor around the multi-resonant antenna 10A of the present modification.

As shown in FIG. 2, the main antenna 30A and the additional radiation element 270A are positioned on a common plane perpendicular to the up-down direction. The multi-resonant antenna 10A is configured so that the main antenna 30A and the additional radiation element 270A are integrally formed with each other. A combination of the main antenna 30A and the additional radiation element 270A is formed of a conductive pattern formed on a substrate (not shown). However, the present invention is not limited thereto. Specifically, the combination of the main antenna 30A and the additional radiation element 270A may be formed of, for example, a metal member which is mounted on a substrate when used.

As shown in FIG. 2, the main antenna 30A comprises a main portion 320 and a feeding portion 210A. Specifically, the main portion 320 has a closed ring shape. The main portion 320 of the present modification has a structure same as that of the main portion 320 of the multi-resonant antenna 10 of the aforementioned embodiment. Accordingly, a detailed explanation thereabout is omitted.

As shown in FIG. 2, the feeding portion 210A extends outward of the main antenna 30A from the main portion 320. The feeding portion 210A is positioned at a location beyond the main portion 320 in the first predetermined direction, or in the negative X-direction. However, the present invention is not limited thereto. The feeding portion 210A may be arranged at a location other than the location beyond the main portion 320 in the negative X-direction. The feeding portion 210A has a first feeding part 220A, a second feeding part 250A, a first feeding point 2421 and a second feeding point 252. The first feeding point 2421 and the second feeding point 252 of the present modification have structures similar to the first feeding point 2421 and the second feeding point 252 of the multi-resonant antenna 10 of the aforementioned embodiment. Accordingly, a detailed explanation thereabout is omitted.

As shown in FIG. 2, the first feeding part 220A extends from the main portion 320 to the first feeding point 2421. The first feeding part 220A has a first section 230 and a second section 240A. The first section 230 has a structure same as that of the first section 230 of the multi-resonant antenna 10 of the aforementioned embodiment. Accordingly, a detailed explanation thereabout is omitted.

As shown in FIG. 2, the second section 240A extends from the first section 230 in the second predetermined direction intersecting with the first predetermined direction. Specifically, the second section 240A extends from the first section 230 in the second predetermined direction perpendicular to the first predetermined direction. The second section 240A extends in the second predetermined direction from an end portion of the first section 230 in the first predetermined direction. The first feeding point 2421 is provided at an end portion of the second section 240A in the second predetermined direction. The second section 240A has a linear portion 2422 and an extension portion 244. The linear portion 2422 extends linearly in the second predetermined direction. The extension portion 244 extends in the first predetermined direction from the linear portion 2422. Specifically, the extension portion 244 extends linearly in the first predetermined direction from the linear portion 2422.

As shown in FIG. 2, the second section 240A has a first segment 241 and a second segment 242A. The first segment 241 of the present modification has a structure same as that of the first segment 241 of the multi-resonant antenna 10 of the aforementioned embodiment. Accordingly, a detailed explanation thereabout is omitted.

As shown in FIG. 2, the second segment 242A extends from the first segment 241. More specifically, the second segment 242A extends linearly in the second predetermined direction from the first segment 241 and is bent so that it extends linearly in the first predetermined direction. In the second predetermined direction, a middle 245A of the second section 240A is positioned between the first segment 241 and the second segment 242A. Specifically, in the second predetermined direction, the middle 245A of the second section 240A is positioned on a boundary between the first segment 241 and the second segment 242A. The first feeding point 2421 is provided at an end portion of the second segment 242A in the second predetermined direction.

As shown in FIG. 2, the second feeding part 250A extends from the main portion 320 to the second feeding point 252. Specifically, the second feeding part 250A extends linearly in the first predetermined direction from the main portion 320 to the second feeding point 252. The second feeding part 250A is positioned at a position same as a position of a third portion 336 in the front-rear direction. The second feeding part 250A is positioned in the first predetermined direction beyond the third portion 336.

As shown in FIG. 2, the additional radiation element 270A extends outward of the main antenna 30A directly from the feeding portion 210A. The additional radiation element 270A extends outward from the feeding portion 210A. The additional radiation element 270A extends in the first predetermined direction from the feeding portion 210A. The additional radiation element 270A extends outward of the main antenna 30A directly from the first feeding part 220A. The additional radiation element 270A extends in the first predetermined direction from the first feeding part 220A.

As shown in FIG. 2, the additional radiation element 270A extends from the second segment 242A including the first feeding point 2421. Accordingly, the additional radiation element 270A extends from the vicinity of the first feeding point 2421. This facilitates impedance matching of the additional radiation element 270A.

As shown in FIG. 2, the additional radiation element 270A has an additional linear portion 272A extending linearly in the second predetermined direction. The additional linear portion 272A extends in the third predetermined direction from the second segment 242A. The linear portion 2422 and the additional linear portion 272A are spaced apart from each other in the lateral direction. The linear portion 2422 and the additional linear portion 272A are parallel to each other. The linear portion 2422 and the additional linear portion 272A form an open slot 260A which is opened at its end. This further facilitates impedance matching of the additional radiation element 270A. The open slot 260A is opened at its end portion in the third predetermined direction.

As shown in FIG. 2, the additional radiation element 270A has a first extending portion 274. Dissimilar to the additional radiation element 270 of the aforementioned embodiment, the additional radiation element 270A has no base portion 271. The first extending portion 274 of the present modification has a structure same as that of the first extending portion 274 of the multi-resonant antenna 10 of the aforementioned embodiment. Accordingly, a detailed explanation thereabout is omitted.

Although the additional radiation element 270A of the present modification has the additional linear portion 272A and the first extending portion 274, the present invention is not limited thereto. Specifically, the additional radiation element 270A may be configured as follows: the additional radiation element 270A has no additional linear portion 272A; and the additional radiation element 270A consists only of the first extending portion 274 which directly extends from the second segment 242A.

The length and shape of the additional radiation element 270A are decided so that the additional radiation element 270A electrically resonates at a desired operating frequency. The desired operating frequency is different from an operating frequency of the main antenna 30A.

As understood from FIG. 2, the multi-resonant antenna 10A of the present modification also has a structure which can electrically resonate at the two operating frequencies, one of which is the operating frequency of the main antenna 30A, or a first resonance portion 30A, and the other of which is the operating frequency of the additional radiation element 270A, or a second resonance portion 270A.

### Second modification

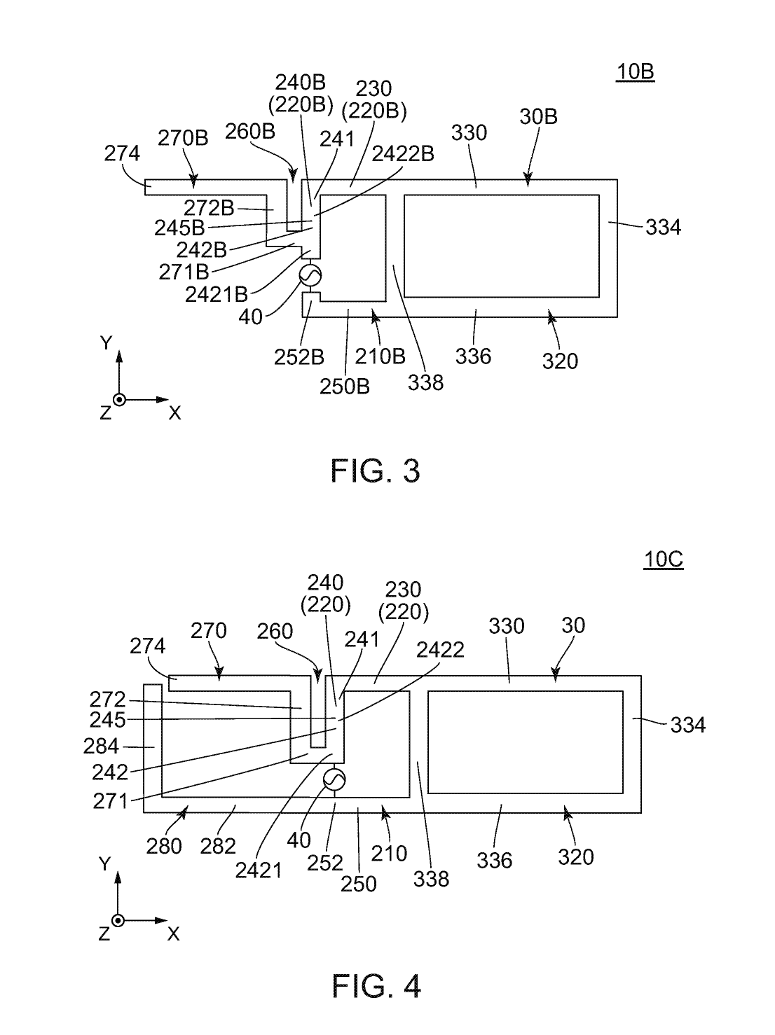

As shown in FIG. 3, a multi-resonant antenna 10B of a second modification comprises a main antenna 30B and an additional radiation element 270B. There is no ground conductor around the multi-resonant antenna 10B of the present modification.

As shown in FIG. 3, the main antenna 30B and the additional radiation element 270B are positioned on a common plane perpendicular to the up-down direction. The multi-resonant antenna 10B is configured so that the main antenna 30B and the additional radiation element 270B are integrally formed with each other. A combination of the main antenna 30B and the additional radiation element 270B is formed of a conductive pattern formed on a substrate (not shown). However, the present invention is not limited thereto. Specifically, the combination of the main antenna 30B and the additional radiation element 270B may be formed of, for example, a metal member which is mounted on a substrate when used.

As shown in FIG. 3, the main antenna 30B comprises a main portion 320 and a feeding portion 210B. Specifically, the main portion 320 has a closed ring shape. The main portion 320 of the present modification has a structure same as that of the main portion 320 of the multi-resonant antenna 10 of the aforementioned embodiment. Accordingly, a detailed explanation thereabout is omitted.

As shown in FIG. 3, the feeding portion 210B extends outward of the main antenna 30B from the main portion 320. The feeding portion 210B is positioned at a location beyond the main portion 320 in the first predetermined direction, or in the negative X-direction. However, the present invention is not limited thereto. The feeding portion 210B may be arranged at a location other than the location beyond the main portion 320 in the negative X-direction. The feeding portion 210B has a first feeding part 220B, a second feeding part 250B, a first feeding point 2421B and a second feeding point 252B.

As shown in FIG. 3, the first feeding part 220B extends from the main portion 320 to the first feeding point 2421B. The first feeding part 220B has a first section 230 and a second section 240B. The first section 230 of the present modification has a structure same as that of the first section 230 of the multi-resonant antenna 10 of the aforementioned embodiment. Accordingly, a detailed explanation thereabout is omitted.

As shown in FIG. 3, the second section 240B extends from the first section 230 in the second predetermined direction intersecting with the first predetermined direction. Specifically, the second section 240B extends from the first section 230 in the second predetermined direction perpendicular to the first predetermined direction. The second section 240B extends in the second predetermined direction from an end portion of the first section 230 in the first predetermined direction. The second section 240B has a linear portion 2422B extending linearly in the second predetermined direction. More specifically, the second section 240B consists only of the linear portion 2422B extending linearly in the second predetermined direction. In the second predetermined direction, the second section 240B of the present modification has a length slightly less than a length of the second section 240 of the aforementioned embodiment. The first feeding point 2421B is provided at an end portion of the second section 240B in the second predetermined direction.

As shown in FIG. 3, the second section 240B has a first segment 241 and a second segment 242B. The first segment 241 of the present modification has a structure similar to that of the first segment 241 of the multi-resonant antenna 10 of the aforementioned embodiment. Accordingly, a detailed explanation thereabout is omitted.

As shown in FIG. 3, the second segment 242B extends from the first segment 241. Specifically, the second segment 242B extends linearly in the second predetermined direction from the first segment 241. In the second predetermined direction, a middle 245B of the second section 240B is positioned between the first segment 241 and the second segment 242B. Specifically, in the second predetermined direction, the middle 245B of the second section 240B is positioned on a boundary between the first segment 241 and the second segment 242B. The first feeding point 2421B is provided at an end portion of the second segment 242B in the second predetermined direction.

As shown in FIG. 3, the second feeding part 250B extends from the main portion 320 to the second feeding point 252B. More specifically, the second feeding part 250B extends linearly in the first predetermined direction from the main portion 320 and is bent so that it extends to the second feeding point 252B in the third predetermined direction. The second feeding part 250B is positioned in the first predetermined direction beyond a third portion 336.

As shown in FIG. 3, an excitation source 40 is connected to the first feeding point 2421B. Specifically, a core wire (not shown) of a coaxial cable (not shown) is connected to the first feeding point 2421B.

As shown in FIG. 3, the excitation source 40 is connected to the second feeding point 252B. Specifically, an outer conductor (not shown) of the coaxial cable is connected to the second feeding point 252B.

As shown in FIG. 3, the additional radiation element 270B extends outward of the main antenna 30B directly from the feeding portion 210B. The additional radiation element 270B extends outward from the feeding portion 210B. The additional radiation element 270B extends in the first predetermined direction from the feeding portion 210B. The additional radiation element 270B extends outward of the main antenna 30B directly from the first feeding part 220B. The additional radiation element 270B extends in the first predetermined direction from the first feeding part 220B.

As shown in FIG. 3, the additional radiation element 270B extends from the second segment 242B including the first feeding point 2421B. Accordingly, the additional radiation element 270B extends from the vicinity of the first feeding point 2421B. This facilitates impedance matching of the additional radiation element 270B.

As shown in FIG. 3, the additional radiation element 270B has an additional linear portion 272B extending linearly in the second predetermined direction. The linear portion 2422B and the additional linear portion 272B are spaced apart from each other in the lateral direction. The linear portion 2422B and the additional linear portion 272B are parallel to each other. The linear portion 2422B and the additional linear portion 272B form an open slot 260B which is opened at its end. This further facilitates impedance matching of the additional radiation element 270B. The open slot 260B is opened at its end portion in the third predetermined direction.

As shown in FIG. 3, the additional radiation element 270B has a base portion 271B and a first extending portion 274. The first extending portion 274 of the present modification has a structure same as that of the first extending portion 274 of the multi-resonant antenna 10 of the aforementioned embodiment. Accordingly, a detailed explanation thereabout is omitted. The base portion 271B extends in the first predetermined direction from the second segment 242B. Specifically, the base portion 271B extends linearly in the first predetermined direction from the second segment 242B. The base portion 271B and the first extending portion 274 are coupled with each other by the additional linear portion 272B. The additional linear portion 272B extends in the third predetermined direction from the base portion 271B.

Although the additional radiation element 270B of the present modification has the base portion 271B, the additional linear portion 272B and the first extending portion 274, the present invention is not limited thereto. The additional radiation element 270B may be configured as follows: the additional radiation element 270B has none of the base portion 271B and the additional linear portion 272B; and the additional radiation element 270B consists only of the first extending portion 274 which extends directly from the second segment 242B.

The length and shape of the additional radiation element 270B are decided so that the additional radiation element 270B electrically resonates at a desired operating frequency. The desired operating frequency is different from an operating frequency of the main antenna 30B.

As understood from FIG. 3, the multi-resonant antenna 10B of the present modification also has a structure which can electrically resonate at the two operating frequencies, one of which is the operating frequency of the main antenna 30B, or a first resonance portion 30B, and the other of which is the operating frequency of the additional radiation element 270B, or a second resonance portion 270B.

### Third modification

As shown in FIG. 4, a multi-resonant antenna 10C of a third modification comprises a main antenna 30, an additional radiation element 270 and an auxiliary radiation element 280. The main antenna 30 and the additional radiation element 270 of the present modification have structures same as those of the main antenna 30 and the additional radiation element 270 of the multi-resonant antenna 10 of the aforementioned embodiment. Accordingly, a detailed explanation thereabout is omitted. There is no ground conductor around the multi-resonant antenna 10C of the present modification.

As shown in FIG. 4, the main antenna 30, the additional radiation element 270 and the auxiliary radiation element 280 are positioned on a common plane perpendicular to the up-down direction. The multi-resonant antenna 10C is configured so that the main antenna 30, the additional radiation element 270 and the auxiliary radiation element 280 are integrally formed with each other. A combination of the main antenna 30, the additional radiation element 270 and the auxiliary radiation element 280 is formed of a conductive pattern formed on a substrate (not shown). However, the present invention is not limited thereto. Specifically, the combination of the main antenna 30, the additional radiation element 270 and the auxiliary radiation element 280 may be formed of, for example, a metal member which is mounted on a substrate when used.

As shown in FIG. 4, the auxiliary radiation element 280 extends outward of the main antenna 30 from a second feeding part 250. More specifically, the auxiliary radiation element 280 linearly extends outward of the main antenna 30 from the second feeding part 250 and is bent so that it extends in the third predetermined direction. The auxiliary radiation element 280 extends in the first predetermined direction from the second feeding part 250. The auxiliary radiation element 280 has an extending portion 282, or a first linear portion 282, and a second linear portion 284.

As shown in FIG. 4, the first linear portion 282 extends in the first predetermined direction from the second feeding part 250. The first linear portion 282 extends linearly in the first predetermined direction from the second feeding part 250. The first linear portion 282 is positioned in the second predetermined direction beyond the additional radiation element 270. In other words, the additional radiation element 270 is positioned in the third predetermined direction beyond the first linear portion 282.

As shown in FIG. 4, the second linear portion 284 extends linearly in the third predetermined direction from the first linear portion 282. The second linear portion 284 is positioned in the first predetermined direction beyond the additional radiation element 270. It is noted that the second linear portion 284 is not coupled with the additional radiation element 270.

The length and shape of the auxiliary radiation element 280 are decided so that the auxiliary radiation element 280 electrically resonates at a desired operating frequency. The desired operating frequency is different from any of operating frequencies of the main antenna 30 and the additional radiation element 270.

As understood from FIG. 4, the auxiliary radiation element 280 operates as a third resonance portion different from any of a first resonance portion and a second resonance portion. The first resonance portion, the second resonance portion and the third resonance portion have resonant frequencies different from each other. Thus, the multi-resonant antenna 10C of the present modification has a structure which can electrically resonate at the three operating frequencies, one of which is the operating frequency of the main antenna 30, or the first resonance portion 30, another of which is the operating frequency of the additional radiation element 270, or the second resonance portion 270, and the other of which is the operating frequency of the auxiliary radiation element 280, or the third resonance portion 280.

### Fourth modification

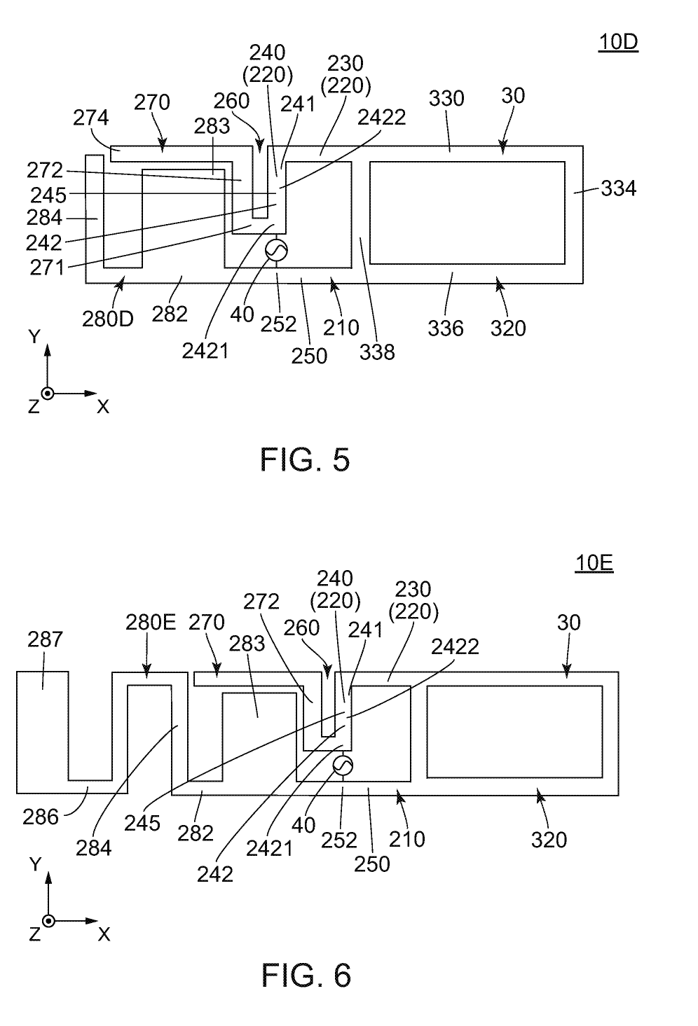

As shown in FIG. 5, a multi-resonant antenna 10D of a fourth modification comprises a main antenna 30, an additional radiation element 270 and an auxiliary radiation element 280D. The main antenna 30 and the additional radiation element 270 of the present modification have structures same as those of the main antenna 30 and the additional radiation element 270 of the multi-resonant antenna 10 of the aforementioned embodiment. Accordingly, a detailed explanation thereabout is omitted. There is no ground conductor around the multi-resonant antenna 10D of the present modification.

As shown in FIG. 5, the main antenna 30, the additional radiation element 270 and the auxiliary radiation element 280D are positioned on a common plane perpendicular to the up-down direction. The multi-resonant antenna 10D is configured so that the main antenna 30, the additional radiation element 270 and the auxiliary radiation element 280D are integrally formed with each other. A combination of the main antenna 30, the additional radiation element 270 and the auxiliary radiation element 280D is formed of a conductive pattern formed on a substrate (not shown). However, the present invention is not limited thereto. Specifically, the combination of the main antenna 30, the additional radiation element 270 and the auxiliary radiation element 280D may be formed of, for example, a metal member which is mounted on a substrate when used.

As shown in FIG. 5, the auxiliary radiation element 280D extends outward of the main antenna 30 from a second feeding part 250. The auxiliary radiation element 280D has an extending portion 282, or a first linear portion 282, a stub 283 and a second linear portion 284. The first linear portion 282 and the second linear portion 284 of the present modification have structures same as those of the first linear portion 282 and the second linear portion 284 of the auxiliary radiation element 280 of the multi-resonant antenna 10C of the third modification. Accordingly, a detailed explanation thereabout is omitted.

As shown in FIG. 5, the stub 283 extends from the first linear portion 282 toward the additional radiation element 270 in the third predetermined direction opposite to the second predetermined direction. The stub 283 is arranged apart from the additional linear portion 272 in the first predetermined direction. The stub 283 is positioned in the second predetermined direction beyond the additional radiation element 270. It is noted that the stub 283 is not coupled with the additional radiation element 270.

The length and shape of the auxiliary radiation element 280D are decided so that the auxiliary radiation element 280D electrically resonates at a desired operating frequency. The desired operating frequency is different from any of operating frequencies of the main antenna 30 and the additional radiation element 270.

As understood from FIG. 5, the auxiliary radiation element 280D operates as a third resonance portion different from any of a first resonance portion and a second resonance portion. The first resonance portion, the second resonance portion and the third resonance portion have resonant frequencies different from each other. Thus, the multi-resonant antenna 10D of the present modification has a structure which can electrically resonate at the three operating frequencies, one of which is the operating frequency of the main antenna 30, or the first resonance portion 30, another of which is the operating frequency of the additional radiation element 270, or the second resonance portion 270, and the other of which is the operating frequency of the auxiliary radiation element 280D, or the third resonance portion 280D.

### Fifth modification

As shown in FIG. 6, a multi-resonant antenna 10E of a fifth modification comprises a main antenna 30, an additional radiation element 270 and an auxiliary radiation element 280E. The main antenna 30 and the additional radiation element 270 have structures same as those of the main antenna 30 and the additional radiation element 270 of the multi-resonant antenna 10 of the aforementioned embodiment. Accordingly, a detailed explanation thereabout is omitted. There is no ground conductor around the multi-resonant antenna 10E of the present modification.

As shown in FIG. 6, the main antenna 30, the additional radiation element 270 and the auxiliary radiation element 280E are positioned on a common plane perpendicular to the up-down direction. The multi-resonant antenna 10E is configured so that the main antenna 30, the additional radiation element 270 and the auxiliary radiation element 280E are integrally formed with each other. A combination of the main antenna 30, the additional radiation element 270 and the auxiliary radiation element 280E is formed of a conductive pattern formed on a substrate (not shown). However, the present invention is not limited thereto. Specifically, the combination of the main antenna 30, the additional radiation element 270 and the auxiliary radiation element 280E may be formed of, for example, a metal member which is mounted on a substrate when used.

As shown in FIG. 6, the auxiliary radiation element 280E extends outward of the main antenna 30 from a second feeding part 250. The auxiliary radiation element 280E has an extending portion 282, or a first linear portion 282, a stub 283, a second linear portion 284, a cranked portion 286 and an additional stub 287. The first linear portion 282, the stub 283 and the second linear portion 284 of the present modification have structures same as those of the first linear portion 282, the stub 283 and the second linear portion 284 of the auxiliary radiation element 280D of the multi-resonant antenna 10D of the fourth modification. Accordingly, a detailed explanation thereabout is omitted.

As shown in FIG. 6, the cranked portion 286 extends in the first predetermined direction from the second linear portion 284. More specifically, the cranked portion 286 extends linearly in the first predetermined direction from the second linear portion 284, and is bent so that it extends linearly in the second predetermined direction, and is further bent so that it extends linearly in the first predetermined direction.

As shown in FIG. 6, the additional stub 287 extends in the third predetermined direction from the cranked portion 286.

The length and shape of the auxiliary radiation element 280E are decided so that the auxiliary radiation element 280E electrically resonates at a desired operating frequency. The desired operating frequency is different from any of operating frequencies of the main antenna 30 and the additional radiation element 270.

As understood from FIG. 6, the auxiliary radiation element 280E operates as a third resonance portion different from any of a first resonance portion and a second resonance portion. The first resonance portion, the second resonance portion and the third resonance portion have resonant frequencies different from each other. Thus, the multi-resonant antenna 10E of the present modification has a structure which can electrically resonate at the three operating frequencies, one of which is the operating frequency of the main antenna 30, or the first resonance portion 30, another of which is the operating frequency of the additional radiation element 270, or the second resonance portion 270, and the other of which is the operating frequency of the auxiliary radiation element 280E, or the third resonance portion 280E.

### Sixth modification

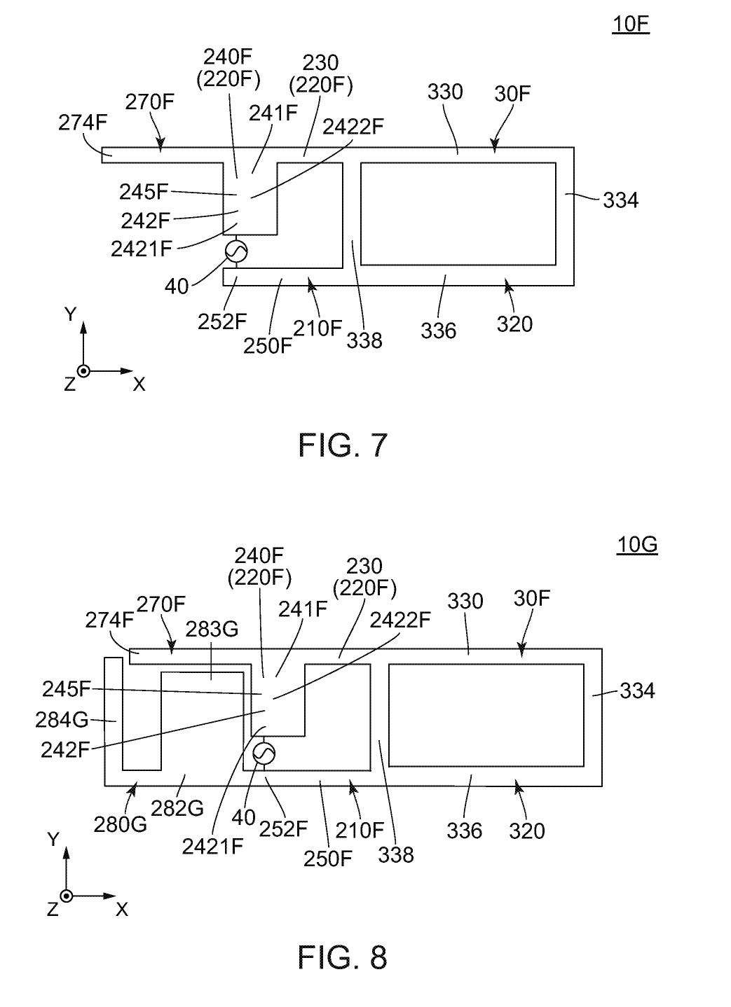

As shown in FIG. 7, a multi-resonant antenna 10F of a sixth modification comprises a main antenna 30F and an additional radiation element 270F. There is no ground conductor around the multi-resonant antenna 10F of the present modification.

As shown in FIG. 7, the main antenna 30F and the additional radiation element 270F are positioned on a common plane perpendicular to the up-down direction. The multi-resonant antenna 10F is configured so that the main antenna 30F and the additional radiation element 270F are integrally formed with each other. A combination of the main antenna 30F and the additional radiation element 270F is formed of a conductive pattern formed on a substrate (not shown). However, the present invention is not limited thereto. Specifically, the combination of the main antenna 30F and the additional radiation element 270F may be formed of, for example, a metal member which is mounted on a substrate when used.

As shown in FIG. 7, the main antenna 30F comprises a main portion 320 and a feeding portion 210F. Specifically, the main portion 320 has a closed ring shape. The main portion 320 of the present modification has a structure same as that of the main portion 320 of the multi-resonant antenna 10 of the aforementioned embodiment. Accordingly, a detailed explanation thereabout is omitted.

As shown in FIG. 7, the feeding portion 210F extends outward of the main antenna 30F from the main portion 320. The feeding portion 210F is positioned at a location beyond the main portion 320 in the first predetermined direction, or in the negative X-direction. However, the present invention is not limited thereto. The feeding portion 210F may be arranged at a location other than the location beyond the main portion 320 in the negative X-direction. The feeding portion 210F has a first feeding part 220F, a second feeding part 250F, a first feeding point 2421F and a second feeding point 252F.

As shown in FIG. 7, the first feeding part 220F extends from the main portion 320 to the first feeding point 2421F. The first feeding part 220F has a first section 230 and a second section 240F. The first section 230 of the present modification has a structure same as that of the first section 230 of the multi-resonant antenna 10 of the aforementioned embodiment. Accordingly, a detailed explanation thereabout is omitted.

As shown in FIG. 7, the second section 240F extends from the first section 230 in the second predetermined direction intersecting with the first predetermined direction. Specifically, the second section 240F extends from the first section 230 in the second predetermined direction perpendicular to the first predetermined direction. The second section 240F extends in the second predetermined direction from an end portion of the first section 230 in the first predetermined direction. The second section 240F has a linear portion 2422F extending linearly in the second predetermined direction. More specifically, the second section 240F consists only of the linear portion 2422F extending linearly in the second predetermined direction. In the lateral direction, a size of the second section 240F is greater than a size of a fourth portion 338. In the lateral direction, a size of the linear portion 2422F is greater than the size of the fourth portion 338.

As shown in FIG. 7, the second section 240F has a first segment 241F and a second segment 242F.

As shown in FIG. 7, the first segment 241F extends from the first section 230. Specifically, the first segment 241F extends linearly in the second predetermined direction from the first section 230. The first segment 241F extends linearly in the second predetermined direction from the end portion of the first section 230 in the first predetermined direction.

As shown in FIG. 7, the second segment 242F extends from the first segment 241F. Specifically, the second segment 242F extends linearly in the second predetermined direction from the first segment 241F. In the second predetermined direction, a middle 245F of the second section 240F is positioned between the first segment 241F and the second segment 242F. Specifically, in the second predetermined direction, the middle 245F of the second section 240F is positioned on a boundary between the first segment 241F and the second segment 242F.

As shown in FIG. 7, the second feeding part 250F extends outward of the main antenna 30F from the main portion 320. The second feeding part 250F extends from the main portion 320 to the second feeding point 252F. Specifically, the second feeding part 250F extends linearly in the first predetermined direction from the main portion 320 to the second feeding point 252F. The second feeding part 250F is positioned at a position same as a position of a third portion 336 in the front-rear direction. The second feeding part 250F is positioned in the first predetermined direction beyond the third portion 336.

As shown in FIG. 7, the first feeding point 2421F is provided at the first feeding part 220F. The first feeding point 2421F is provided at an end portion of the second section 240F in the second predetermined direction. More in detail, the first feeding point 2421F is provided at the end portion of the second section 240F, wherein the end portion is positioned at its end in the first predetermined direction, or in the negative X-direction, and is positioned at its end in the second predetermined direction, or in the negative Y-direction. The first feeding point 2421F is provided at an end portion of the second segment 242F in the second predetermined direction. More in detail, the first feeding point 2421F is provided at the end portion of the second segment 242F, wherein the end portion is positioned at its end in the first predetermined direction, or in the negative X-direction, and is positioned at its end in the second predetermined direction, or in the negative Y-direction. An excitation source 40 is connected to the first feeding point 2421F. Specifically, a core wire (not shown) of a coaxial cable (not shown) is connected to the first feeding point 2421F.

As shown in FIG. 7, the second feeding point 252F is provided at the second feeding part 250F. The excitation source 40 is connected to the second feeding point 252F. Specifically, an outer conductor (not shown) of the coaxial cable is connected to the second feeding point 252F.

As shown in FIG. 7, the additional radiation element 270F extends outward of the main antenna 30F directly from the feeding portion 210F. The additional radiation element 270F extends outward from the feeding portion 210F. The additional radiation element 270F extends in the first predetermined direction from the feeding portion 210F. The additional radiation element 270F extends outward of the main antenna 30F directly from the first feeding part 220F. The additional radiation element 270F extends in the first predetermined direction from the first feeding part 220F. The additional radiation element 270F extends in the first predetermined direction from the second section 240F. The additional radiation element 270F extends in the first predetermined direction from the first segment 241F.

As shown in FIG. 7, dissimilar to the aforementioned additional radiation element 270, 270A, 270B, the additional radiation element 270F of the present modification has none of the base portion 271, 271B and the additional linear portion 272, 272A, 272B and consists only of a first extending portion 274F. Accordingly, the multi-resonant antenna 10F of the present modification has no open slot 260, 260A, 260B dissimilar to the multi-resonant antenna 10, 10A, 10B, 10C, 10D, 10E. As described above, the multi-resonant antenna 10F of the present modification is configured so that the size of the second section 240F in the lateral direction is greater than the size of the fourth portion 338 in the lateral direction. Thus, the multi-resonant antenna 10F of the present modification can have an excellent antenna characteristic even though the multi-resonant antenna 10F has no open slot 260, 260A, 260B. It is noted that the first extending portion 274F extends in the first predetermined direction from the first segment 241F.

The length and shape of the additional radiation element 270F are decided so that the additional radiation element 270F electrically resonates at a desired operating frequency. The desired operating frequency is different from an operating frequency of the main antenna 30F.

As understood from FIG. 7, the multi-resonant antenna 10F of the present modification also has a structure which can electrically resonate at the two operating frequencies, one of which is the operating frequency of the main antenna 30F, or a first resonance portion 30F, and the other of which is the operating frequency of the additional radiation element 270F, or a second resonance portion 270F.

### Seventh modification

As shown in FIG. 8, a multi-resonant antenna 10G of a seventh modification comprises a main antenna 30F, an additional radiation element 270F and an auxiliary radiation element 280G. The main antenna 30F and the additional radiation element 270F of the present modification have structures same as those of the main antenna 30F and the additional radiation element 270F of the multi-resonant antenna 10F of the sixth modification. Accordingly, a detailed explanation thereabout is omitted. There is no ground conductor around the multi-resonant antenna 10G of the present modification.

As shown in FIG. 8, the main antenna 30F, the additional radiation element 270F and the auxiliary radiation element 280G are positioned on a common plane perpendicular to the up-down direction. The multi-resonant antenna 10G is configured so that the main antenna 30F, the additional radiation element 270F and the auxiliary radiation element 280G are integrally formed with each other. A combination of the main antenna 30F, the additional radiation element 270F and the auxiliary radiation element 280G is formed of a conductive pattern formed on a substrate (not shown). However, the present invention is not limited thereto. Specifically, the combination of the main antenna 30F, the additional radiation element 270F and the auxiliary radiation element 280G may be formed of, for example, a metal member which is mounted on a substrate when used.

As shown in FIG. 8, the auxiliary radiation element 280G extends outward of the main antenna 30F from a second feeding part 250F. The auxiliary radiation element 280G has an extending portion 282G, or a first linear portion 282G, a stub 283G and a second linear portion 284G.

As shown in FIG. 8, the first linear portion 282G extends in the first predetermined direction from the second feeding part 250F. The first linear portion 282G extends linearly in the first predetermined direction from the second feeding part 250F. The first linear portion 282G is positioned in the second predetermined direction beyond the additional radiation element 270F. In other words, the additional radiation element 270F is positioned in the third predetermined direction beyond the first linear portion 282G.

As shown in FIG. 8, the stub 283G extends from the first linear portion 282G toward the additional radiation element 270F in the third predetermined direction opposite to the second predetermined direction. The stub 283G is arranged apart from a second section 240F in the first predetermined direction. The stub 283G is positioned in the second predetermined direction beyond the additional radiation element 270F. It is noted that the stub 283G is not coupled with the additional radiation element 270F.

As shown in FIG. 8, the second linear portion 284G extends linearly in the third predetermined direction from the first linear portion 282G. The second linear portion 284G is positioned in the first predetermined direction beyond the additional radiation element 270F. It is noted that the second linear portion 284G is not coupled with the additional radiation element 270F.

The length and shape of the auxiliary radiation element 280G are decided so that the auxiliary radiation element 280G electrically resonates at a desired operating frequency. The desired operating frequency is different from any of operating frequencies of the main antenna 30F and the additional radiation element 270F.

As understood from FIG. 8, the auxiliary radiation element 280G operates as a third resonance portion different from any of a first resonance portion and a second resonance portion. The first resonance portion, the second resonance portion and the third resonance portion have resonant frequencies different from each other. Thus, the multi-resonant antenna 10G of the present modification has a structure which can electrically resonate at the three operating frequencies, one of which is the operating frequency of the main antenna 30F, or the first resonance portion 30F, another of which is the operating frequency of the additional radiation element 270F, or the second resonance portion 270F, and the other of which is the operating frequency of the auxiliary radiation element 280G, or the third resonance portion 280G.

### Eighth modification

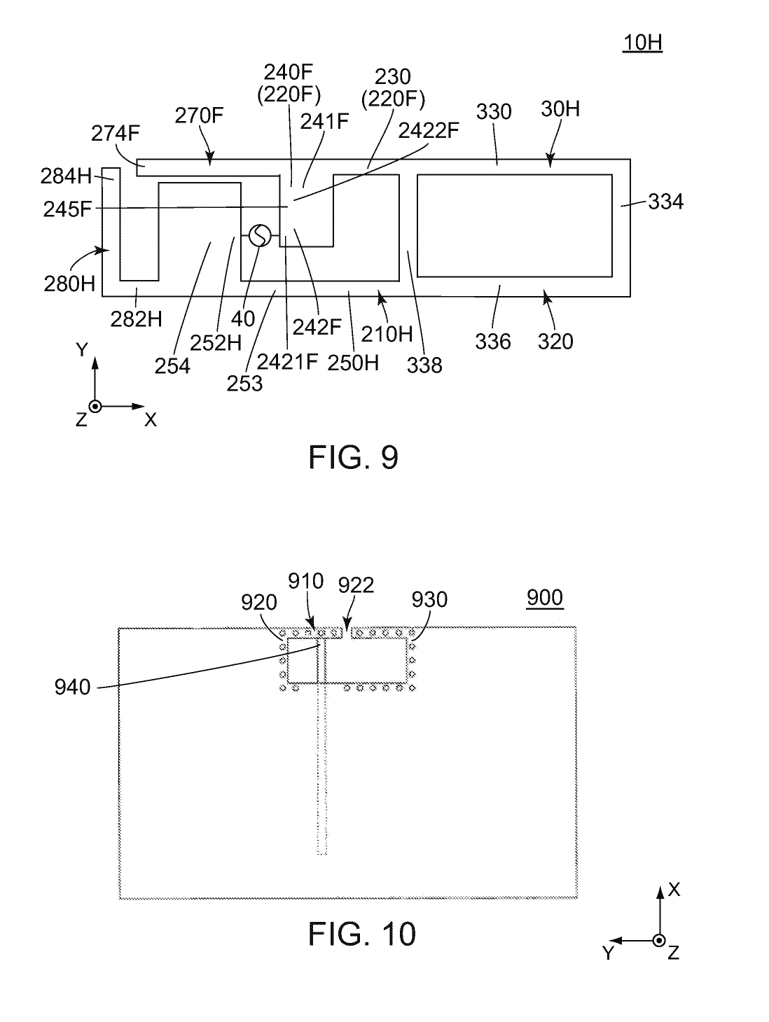

As shown in FIG. 9, a multi-resonant antenna 10H of an eighth modification comprises a main antenna 30H, an additional radiation element 270F and an auxiliary radiation element 280H. The additional radiation element 270F of the present modification has a structure same as that of the additional radiation element 270F of the multi-resonant antenna 10F of the sixth modification. Accordingly, a detailed explanation thereabout is omitted. There is no ground conductor around the multi-resonant antenna 10H of the present modification.

As shown in FIG. 9, the main antenna 30H, the additional radiation element 270F and the auxiliary radiation element 280H are positioned on a common plane perpendicular to the up-down direction. The multi-resonant antenna 10H is configured so that the main antenna 30H, the additional radiation element 270F and the auxiliary radiation element 280H are integrally formed with each other. A combination of the main antenna 30H, the additional radiation element 270F and the auxiliary radiation element 280H is formed of a conductive pattern formed on a substrate (not shown). However, the present invention is not limited thereto. Specifically, the combination of the main antenna 30H, the additional radiation element 270F and the auxiliary radiation element 280H may be formed of, for example, a metal member which is mounted on a substrate when used.

As shown in FIG. 9, the main antenna 30H comprises a main portion 320 and a feeding portion 210H. Specifically, the main portion 320 has a closed ring shape. The main portion 320 of the present modification has a structure same as that of the main portion 320 of the multi-resonant antenna 10 of the aforementioned embodiment. Accordingly, a detailed explanation thereabout is omitted.

As shown in FIG. 9, the feeding portion 210H extends outward of the main antenna 30H from the main portion 320. The feeding portion 210H is positioned at a location beyond the main portion 320 in the first predetermined direction, or in the negative X-direction. However, the present invention is not limited thereto. The feeding portion 210H may be arranged at a location other than the location beyond the main portion 320 in the negative X-direction. The feeding portion 210H has a first feeding part 220F, a second feeding part 250H, a first feeding point 2421F and a second feeding point 252H. The first feeding part 220F and the first feeding point 2421F of the present modification have structures similar to the first feeding part 220F and the first feeding point 2421F of the multi-resonant antenna 10F of the sixth modification. Accordingly, a detailed explanation thereabout is omitted.

As shown in FIG. 9, the second feeding part 250H extends outward of the main antenna 30H from the main portion 320. The second feeding part 250H is positioned in the first predetermined direction beyond a third portion 336. The second feeding part 250H has a third section 253 and a fourth section 254. The third section 253 extends in the first predetermined direction from the main portion 320. The third section 253 is positioned at a position same as a position of the third portion 336 in the front-rear direction. The third section 253 is positioned in the first predetermined direction beyond the third portion 336. The fourth section 254 extends from the third section 253 toward the additional radiation element 270F in the third predetermined direction opposite to the second predetermined direction. The fourth section 254 is arranged apart from a second section 240F in the first predetermined direction. It is noted that a part of the fourth section 254 functions as a stub.

As shown in FIG. 9, the second feeding point 252H is provided at the second feeding part 250H. Specifically, the second feeding point 252H is provided at the fourth section 254. An excitation source 40 is connected to the second feeding point 252H. Specifically, an outer conductor (not shown) of a coaxial cable (not shown) is connected to the second feeding point 252H.

As shown in FIG. 9, the auxiliary radiation element 280H extends outward of the main antenna 30H from the second feeding part 250H. The auxiliary radiation element 280H extends in the first predetermined direction from the second feeding part 250H. More specifically, the auxiliary radiation element 280H linearly extends in the first predetermined direction from the second feeding part 250H and is bent so that it extends in the third predetermined direction. The auxiliary radiation element 280H has a first linear portion 282H and a second linear portion 284H.

As shown in FIG. 9, the first linear portion 282H extends in the first predetermined direction from the second feeding part 250H. The first linear portion 282H extends linearly in the first predetermined direction from the second feeding part 250H. The first linear portion 282H is positioned in the second predetermined direction beyond the additional radiation element 270F. In other words, the additional radiation element 270F is positioned in the third predetermined direction beyond the first linear portion 282H.

As shown in FIG. 9, the second linear portion 284H extends linearly in the third predetermined direction from the first linear portion 282H. The second linear portion 284H is positioned in the first predetermined direction beyond the additional radiation element 270F. It is noted that the second linear portion 284H is not coupled with the additional radiation element 270F.

The length and shape of the auxiliary radiation element 280H are decided so that the auxiliary radiation element 280H electrically resonates at a desired operating frequency. The desired operating frequency is different from any of operating frequencies of the main antenna 30H and the additional radiation element 270F.

As understood from FIG. 9, the auxiliary radiation element 280H operates as a third resonance portion different from any of a first resonance portion and a second resonance portion. The first resonance portion, the second resonance portion and the third resonance portion have resonant frequencies different from each other. Thus, the multi-resonant antenna 10H of the present modification has a structure which can electrically resonate at the three operating frequencies, one of which is the operating frequency of the main antenna 30H, or the first resonance portion 30H, another of which is the operating frequency of the additional radiation element 270F, or the second resonance portion 270F, and the other of which is the operating frequency of the auxiliary radiation element 280H, or the third resonance portion 280H.

Although the specific explanation about the present invention is made above referring to the embodiment and modifications, the present invention is not limited thereto and is susceptible to various modifications and alternative forms.

Although there is no ground conductor around the multi-resonant antennas 10, 10A, 10B, 10C, 10D, 10E, 10F, 10G, 10H of the aforementioned embodiment and modifications, the present invention is not limited thereto. Specifically, a ground conductor may be provided at a location beyond the main antenna 30, 30A, 30B, 30F, 30H in a positive X-direction. Additionally, a ground conductor may be provided at a location beyond the main antenna 30, 30A, 30B, 30F, 30H in the second predetermined direction, or in the negative Y-direction. Furthermore, a ground conductor may be provided at a location beyond the auxiliary radiation element 280, 280D, 280E, 280G, 280H in the second predetermined direction, or in the negative Y-direction.

Although the multi-resonant antennas 10C, 10D, 10E, 10G, 10H of the aforementioned modifications comprise the auxiliary radiation elements 280, 280D, 280E, 280G, 280H, the present invention is not limited thereto. Specifically, the multi-resonant antenna 10C, 10D, 10E, 10G, 10H may comprise no auxiliary radiation element 280, 280D, 280E, 280G, 280H.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A multi-resonant antenna comprising a main antenna and an additional radiation element, wherein:
the main antenna comprises a main portion and a feeding portion;
the main portion has a closed ring shape;
the feeding portion has a first feeding part, a second feeding part, a first feeding point and a second feeding point;
each of the first feeding part and the second feeding part extends outward of the main antenna from the main portion;
the first feeding point is provided at the first feeding part;
the second feeding point is provided at the second feeding part; and
the additional radiation element extends outward of the main antenna directly from the first feeding part.

2. The multi-resonant antenna as recited in claim 1, wherein:
the first feeding part has a first section and a second section;
the first section extends from the main portion in a first predetermined direction;
second section extends from the first section in a second predetermined direction intersecting with the first predetermined direction;
the second section has a first segment and a second segment;
the first segment extends from the first section;
the second segment extends from the first segment;
in the second predetermined direction, a middle of the second section is positioned between the first segment and the second segment;
the first feeding point is provided at an end portion of the second segment in the second predetermined direction;
the second feeding part extends from the main portion to the second feeding point; and
the additional radiation element extends from the second segment.

3. The multi-resonant antenna as recited in claim 2, wherein:
the second section has a linear portion extending linearly in the second predetermined direction;
the additional radiation element has an additional linear portion extending linearly in the second predetermined direction;
the linear portion and the additional linear portion are parallel to each other; and
the linear portion and the additional linear portion form an open slot which is opened at its end.

4. The multi-resonant antenna as recited in claim 1, wherein:
the first feeding part has a first section and a second section;
the first section extends from the main portion in a first predetermined direction;
the second section extends from the first section in a second predetermined direction intersecting with the first predetermined direction;
the second section has a first segment and a second segment;
the first segment extends from the first section;
the second segment extends from the first segment;
in the second predetermined direction, a middle of the second section is positioned between the first segment and the second segment;
the first feeding point is provided at an end portion of the second segment in the second predetermined direction;
the second feeding part extends from the main portion to the second feeding point; and
the additional radiation element extends from the first segment.

5. The multi-resonant antenna as recited in claim 4, wherein:
the multi-resonant antenna has an extending portion and a stub;
the extending portion extends from the second feeding part in the first predetermined direction;
the stub extends from the extending portion toward the additional radiation element in a third predetermined direction opposite to the second predetermined direction; and
the stub is arranged apart from the second section in the first predetermined direction.

6. The multi-resonant antenna as recited in claim 4, wherein:
the second feeding part has a third section and a fourth section;
the third section extends from the main portion in the first predetermined direction;
the fourth section extends from the third section toward the additional radiation element in a third predetermined direction opposite to the second predetermined direction; and
the fourth section is arranged apart from the second section in the first predetermined direction.

7. The multi-resonant antenna as recited in claim 1, wherein the multi-resonant antenna further comprises an auxiliary radiation element which extends outward of the main antenna from the second feeding part.
